(19) United States
(12) Patent Application Publication
(10) Pub. No.: US 2026/0295978 A1
(43) Pub. Date: Oct. 1, 2026

(54) LAMINATION OF TWO GLASS SHEETS BY INJECTION

(71) Applicant: AGC GLASS EUROPE, Louvain-la-Neuve (BE)

(72) Inventors: Robert HICK, Gosselies (BE); Laurent VANDIEVOET, Gosselies (BE); Thomas LAMBRICHT, Gosselies (BE)

(73) Assignee: AGC GLASS EUROPE, Louvain-la-Neuve (BE)

(21) Appl. No.: 19/475,788

(22) PCT Filed: Jul. 8, 2024
(86) PCT No.: PCT/EP2024/069185

§ 371 Date: Oct. 16, 2025

(30) Foreign Application Priority Data
Jul. 10, 2023 (EP) 23184349.1

(51) Int. Cl. B32B 17/10

(52) U.S. Cl. CPC B32B 17/10917; B32B 17/10036; B32B 17/1055; B32B 2250/03; B32B 2250/40; B32B 2307/7376

(57) ABSTRACT

An assembly having a first glass sheet having an internal face and second glass sheet having an internal face. The assembly also has an injected plastic material laminating the first glass sheet and the second glass sheet together. The injected plastic material is made of a thermoplastic material or a thermoset material. The injected plastic material covers at least 50%, preferably at least 75%, more preferably at least 90%, even more preferably 100% of the internal face of both the first glass sheet and the second glass sheet. A process to laminate together a first glass sheet having an internal face and a second glass sheet is also described.

### FIELD OF THE INVENTION

The present invention relates to the field of laminated glass sheets. More specifically it relates to a laminate made of at least two glass sheets and an injected material in between. It also relates to a method to produce such laminated glass sheets.

### BACKGROUND OF THE INVENTION

Laminated glass is constructed of at least two glass sheets which are bonded together with at least one interlayer to form a permanent bond. The at least one interlayer works to support and hold the glass sheets to create a strong, uniformed layer even when broken. Laminated glass comes in varying thicknesses and can be created using different glass combinations or coatings to provide different qualities, such as low emissions or increased insulation.

Laminated glass is used in a wide range of applications due to its enhanced safety and other beneficial properties. Laminated glass is extensively used in automobile windshields. It provides safety by preventing the glass from shattering into sharp fragments upon impact, reducing the risk of injury to passengers. Laminated glass also improves the structural integrity of the windshield, protecting occupants during accidents. It may also be used in side and rear windows of vehicles. It may further be used as exterior or interior trim element. An exterior trim element includes bumper, window/door seal, pillar, wheel well, wheel arch, fender, headlight, mirror body and roof cover. Such exterior trim element can also be deployable, meaning it can pop out from the vehicle only when needed. Vehicle manufacturers use these exterior trim elements to add aesthetics, increase function, and add flexibility to the vehicle design. An interior trim element is mounted on any part in the vehicle's interior in order to provide a better aesthetic or to secure or protect some part of the vehicle's interior. Such interior trim element can be mounted to cover (either fully or partially) doors, door handles contours, parts of the dashboard or the center console (where the center console means the console between the front passengers' seats, which can extend towards the dashboard), back of seats (including headrest's back), roofs, armrests, . . . . A vehicle refers to any kind of vehicles such as (but not restricted to) a car, a van, a lorry, a motorbike, a bus, a tram, a train, a drone, an airplane, an helicopter and the like.

Laminated glass is used in windows, doors, and facades of buildings. It enhances safety by minimizing the risk of injuries from broken glass, especially in high-rise structures or areas prone to severe weather conditions. Laminated glass can provide protection against forced entry and help withstand impacts from flying debris or extreme wind loads.

It also offers sound insulation, UV protection, and can be designed to control solar heat gain. Laminated glass is commonly used in skylights and canopies to provide safety and protection.

Laminated glass is utilized in balustrades, staircases, and railings to provide a safe barrier while maintaining transparency and aesthetics. In regions prone to hurricanes, laminated glass is used to reinforce windows and doors. It helps protect against high winds, flying debris, and pressure changes during storms. Laminated glass can withstand impacts from windborne objects, reducing the risk of breakage and maintaining the structural integrity of buildings.

Laminated glass is utilized in security applications that require protection against break-ins, vandalism, or ballistic threats. It can be manufactured with multiple layers of glass and interlayers to increase strength and resistance to penetration. Such specialized laminated glass is commonly used in banks, government buildings, jewelry stores, and other high-security installations.

The interlayer is typically a film made of polyvinyl butyral (PVB), ethylene-vinyl acetate (EVA) or thermoplastic polyurethane (TPU). Modern laminated glass is produced by bonding two or more sheets of ordinary annealed or tempered glass together with such interlayer.

The process of making laminated glass usually involves several steps. The first step is to cut the glass sheets to the desired size and shape. This is typically done using automated cutting machines or manual scoring and breaking techniques. The glass surfaces are then thoroughly cleaned to remove any dirt, dust, or contaminants that could affect the bonding process. The glass is usually washed and dried to ensure a clean surface. Then, a layer of interlayer material, typically made of polyvinyl butyral (PVB), ethylene-vinyl acetate (EVA) or thermoplastic polyurethane (TPU), is placed between the glass sheets. The interlayer is cut to match the size and shape of the glass and is positioned evenly. The glass sheets and interlayer are carefully aligned then usually passed through a series of rollers or vacuum bagging systems to expel any air pockets. The entire assembly is placed in a specialized press or autoclave that applies heat and pressure to bond the layers. The assembly is subjected to heat and pressure. The temperature and pressure applied during this step are specific to the type of interlayer material being used. The heat softens the interlayer, and the pressure helps to ensure a strong bond between the glass layers and the interlayer. As the interlayer heats up, it becomes adhesive and starts bonding with the glass. The heat and pressure continue to be applied until the interlayer fully adheres to the glass surfaces. This process is known as lamination. Once the bonding is complete, the laminated glass cools gradually to stabilize the interlayer and to solidify the bond. After cooling, the edges of the laminated glass may be trimmed and polished to achieve a smooth and finished appearance.

Lamination is usually done with glass sheets of a thickness of at least 1.6 mm, more generally 2.1 mm, in order to obtain a sufficient rigidity. It is indeed the glass sheets which are contributing to the rigidity of the final assembly, as the interlayer is usually a film which is very thin. This leads to a final assembly which is quite heavy. In automotive especially, any gain in weight results in less CO₂ emission. So lighter laminated glass sheets would be highly interesting, especially in the automotive industry.

Besides, current lamination processes are quite complex and usually difficult to automatize.

### SUMMARY OF THE INVENTION

The present invention concerns an assembly. The assembly comprises at least a first glass sheet having an internal face. The assembly further comprises at least a second glass sheet having an internal face. The assembly further comprises an injected plastic material laminating the at least first glass sheet and the at least second glass sheet together. Such injected plastic material is made of a thermoplastic material or a thermoset material. The injected plastic material covers at least 50%, preferably at least 75%, more preferably at least 90%, even more preferably 100% of the internal face of both the at least first glass sheet and the at least second glass sheet.

The present invention further concerns a process to laminate together at least a first glass sheet having an internal face and at least a second glass sheet having an internal face. The process comprises the following steps:
i. Providing at least a first glass sheet and at least a second glass sheet;
ii. Placing the internal face of the at least first glass sheet in front of the internal face of the at least second glass sheet to create a volume;
iii. Injecting a plastic material into the volume to create a laminate, the plastic material filling at least 50%, preferably at least 75%, more preferably at least 90%, even more preferably 100% of the volume, the plastic material being a thermoplastic material or a thermoset material.

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

In this document to a specific embodiment and include various changes, equivalents, and/or replacements of a corresponding embodiment. The same reference numbers are used throughout the drawings to refer to the same or like parts.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

### BRIEF DESCRIPTION OF THE DRAWINGS

FIG. 1-4b illustrate various embodiments of the assembly according to the present invention.

FIG. 5a-d illustrate an example of the process according to the present invention.

FIGS. 6a-b and 7a-b illustrate various embodiment of the different steps of the process according to the present invention.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes an assembly. This assembly comprises at least a first glass sheet having an internal face and at least a second glass sheet having an internal face. The at least first and at least second glass sheets have a composition that is not particularly limited. The glass sheets may be a soda-lime-silicate glass, an alumino-silicate glass, an alkali-free glass, a boro-silicate glass, . . . . Preferably, the glass sheets of the invention are made of a soda-lime glass or an alumino-silicate glass.

The glass sheets according to the invention may be a glass sheet obtained by a floating process, a drawing process, a rolling process or any other process known to manufacture a glass sheet starting from a molten glass composition. According to a preferred embodiment, the glass sheets may be float glass sheets. The term “float glass sheet” is understood to mean a glass sheet formed by the float glass process, which consists in pouring the molten glass onto a bath of molten tin, under reducing conditions.

The glass sheets can have a thickness less than or equal to 5.0 mm, preferably less than or equal to 3 mm, more preferably less than or equal to 2.1 mm, even more preferably less than or equal to 1.1 mm. The glass sheets can have a thickness equal to or higher than 0.5 mm, preferably equal to or higher than 0.7 mm. The thinner the glass sheets, the lighter the assembly.

Besides, ultrathin glass sheets, meaning glass sheets with a thickness equal to or below 2.0 mm, are more easily bended as there is less constraints in the glass.

Another advantage of ultrathin glass sheets is the possibility to lower the weight of the assembly while still keeping a sufficient rigidity of the assembly. For example, for an assembly made of two glass sheets of 0.7 mm each, laminated with a thermoplastic elastomer of 2.0 mm, there could be a reduction of weight of 30% compared to current laminated glass sheets using two 1.6 mm or more usually 2.1 mm thick glass sheets and a usual thermoplastic interlayer film (not injected), as usually produced in the automotive industry.

The glass sheets may have different thicknesses, meaning the at least first glass sheet may for example have a thickness of 1.7 mm and the at least second glass sheet may have a thickness of 2.1 mm.

At least one of the at least first and second glass sheets may be chemically or thermally tempered or annealed. Tempered glass, or toughened glass, is a high-strength glass stronger than ordinary glass. To make chemically tempered glass, glass is sunk into 400° C. alkali salt solution, so that the glass surface will have chemically exchange between small radius ions in glass and larger radius ions in the solution. For example, lithium ions in the glass are exchanged with potassium or sodium ions in the solution, and sodium ions in the glass are exchanged with potassium ions in the solution. The difference in the volume of alkali ions is used to form intercalation stress on glass surface. To make thermally tempered glass, glass is heated to a high temperature and then rapidly cooled, therefore forming a durable outer layer that can withstand impacts and temperature changes with ease.

At least one of the at least first and second glass sheets may be curved. One of the glass sheet being curved, the other glass sheet will be curved too, as it will be laminated through the injected plastic material to the curved one. It may be easier and quicker than laminating two curved glass sheets.

The assembly further comprises an injected plastic material laminating the at least first glass sheet and the at least second glass sheet together. The injected plastic material is made of a thermoplastic material or a thermoset material.

The injected plastic covers at least 50%, preferably at least 75%, more preferably at least 90%, even more preferably 100% of the internal face of both the at least first glass sheet and the at least second glass sheet. The higher the coverage, the stronger the lamination.

One advantage of covering 100% of the internal faces is to avoid glass shards from any of the glass sheets in case of breakage of the assembly.

The injected plastic material can have a visible (meaning between 480 nm and 780 nm) light transmission of at least 40%, preferably at least 60%, more preferably at least 80%, even more preferably at least 90%, measured conformed to ISO13468-1:2019 for a 3 mm-thick sample. Such visible light transmission allows for the assembly to be sufficiently transparent to see through. Such transparency can be interesting in case of back lighting, allowing to see some light source through the assembly. Such assembly can also be put in front of a display.

In a preferred embodiment, the injected plastic material is a thermoplastic material. Thermoplastic material are usually not expensive. They are also very easy to inject, making implementation easier and faster. Such thermoplastic material can be a soft polyvinyl chloride or a thermoplastic elastomer, such as a thermoplastic styrenic elastomer (TPS), an acrylic-based thermoplastic elastomer, a thermoplastic polyurethane (TPU), a thermoplastic olefinic elastomer (TPO), a co-polyester (CPE) or a co-polyamide (CPA). TPS has a low viscosity range with an attractive cost. TPU could have better mechanical properties, but with a higher cost and is more difficult to process. TPS is widely used for standard automotive window encapsulation and exhibit good adhesion properties to glass, particularly when used with a dedicated primer.

According to a preferred embodiment, the melt flow rate of the thermoplastic material is at least 10 g per 10 minutes, preferably at least 30 g per 10 minutes, more preferably at least 80 g per 10 minutes, even more preferably at least 100 g per 10 minutes, measured conformed to ISO1133-1:2022 for 2.16 kg and at 230° C. The higher the melt flow rate, the more fluid the thermoplastic material. If the thermoplastic material is more fluid, then less injection gates are needed to inject the thermoplastic material. The lower the number of injection gates, the more homogeneous is the injection. There are indeed therefore less weld lines. A weld line is the line where two flow fronts meet when there is the inability of two or more flow fronts to weld, during the moulding process. These lines cause locally weak areas in the moulded part.

According to a preferred embodiment, the injected plastic material is a thermoset material. Thermoset materials are usually very fluid. They also generally show a higher resistance to temperature above 100° C.

The thermoset material can be a polyurethane-based thermoset, a silicone-based thermoset or an ethylene-vinyl acetate-based thermoset. Due to its low viscosity, a thermoset material is easier to inject, and therefore allows to create long pieces. The temperature resistance of the assembly could also be higher. Moreover, the optical performance could be higher due to the lower stress induced during the process.

In a preferred embodiment, the injected plastic material has a haze less than or equal to 5%, preferably less than or equal to 2%, more preferably less than or equal to 1%, even more preferably less than or equal to 0.5%, measured according to ISO14782:2021 for a 3 mm-thick sample. Such low haze value could be beneficial for applications whereas the transparency is required to be high, such as a usual glazing or a camera cover.

In a preferred embodiment, the injected plastic material has a haze of at least 5%, preferably equal to or at least 50%, more preferably equal to or at least 75%, even more preferably equal to or at least 90%, measured according to ISO13468-1:2019 for a 3 mm-thick sample. Such high haze value could be interesting for applications whereas it is sought to diffuse light homogeneously, such as for trim element with backlighting.

In a preferred embodiment, the thickness of the injected plastic material is less than or equal to 4.0 mm, preferably less than or equal to 3.0 mm, more preferably less than or equal to 2.5 mm. The thickness of the injected plastic material is equal to or higher than 0.8 mm, preferably equal to or higher than 1.5 mm, more preferably equal to or higher than 2.0 mm. Such thickness allows to ease the injection of the injected material, while having a weak impact on the optical properties of the assembly and ensuring the rigidity of the assembly. It further allows to reduce the weight of the assembly, as the density of the injected plastic material is around 1 gr/cm³, and therefore much lower than glass.

The use of ultra-thin glass sheet (meaning glass sheet with a thickness equal to or lower than 2.0 mm) leads to a high weight reduction with a low impact on product rigidity. The ratio stiffness/weight is increased.

Depending on the thickness of the glass sheets and of the thickness and shear modulus of the injected plastic material, the ratio stiffness/weight of the assembly may be increased.

The present invention also relates to a process to laminate together at least a first glass sheet having an internal face and at least a second glass sheet having an internal face.

The process comprises a first step of providing the at least first glass sheet and the at least second glass sheet.

The process comprises a second step of placing the internal face of the at least first glass sheet in front of the internal face of the at least second glass sheet to create a volume. Here “in front of” means that the internal face of the at least first glass sheet is facing the internal face of the at least second glass sheet.

The process comprises the third step of injecting a plastic material into the volume to create a laminate. The plastic material fills at least 50%, preferably at least 75%, more preferably at least 90%, even more preferably 100% of the volume. The plastic material is a thermoplastic material or a thermoset material.

Such process allows to reduce the number of steps required to produce laminated glass sheets, therefore further reducing the costs.

Such process further allows a better automatization of the process itself, compared to current used lamination methods, therefore also further reducing the costs.

In a preferred embodiment, the plastic material has a visible light transmission of at least 40%, preferably at least 60%, more preferably at least 80%, even more preferably at least 90%, measured conformed to ISO13468-1:2019 for a 3 mm-thick sample.

According to a preferred embodiment wherein the plastic material is a thermoplastic material, the process comprises a fourth step of cooling the thermoplastic material at a temperature below 150° C., preferably below 100° C., more preferably below 80° C. to create an assembly.

According to a preferred embodiment wherein the plastic material is a thermoset material, the process comprises a fourth step of curing the thermoset material for at least 2 minutes, preferably at least 1 minute, more preferably at least 50 seconds to create an assembly.

The cooling or the curing ensures the assembly to be sufficiently rigid in order to allow the extraction of the assembly.

Such process can be performed using a mould. Usually, moulds are made from metal, usually aluminium or steel, and precision machined to match the features of the product to produce.

In a preferred embodiment, the at least first glass sheet and the at least second glass sheet are disposed in a mould. The mould can comprise a fixed part and a mobile part. At least portions of both parts and internal faces of the at least first glass sheet and second glass sheet then define the volume. The at least first glass sheet is provided on one of the part and the at least second glass sheet is provided on the other part.

In case of thermoplastic material, the thermoplastic material is fed into a heated barrel and mixed using a helical shaped screw. The molten thermoplastic material is then injected into the volume where it cools and hardens. The cooling time can be reduced through the use of cooling lines that circulate water or oil from an external temperature controller. The mould is then opened once the thermoplastic material has solidified so that ejector pins can eject the assembly from the mould.

In case of thermoset material, the thermoset material is generally poured at low pressure into the mould. Then an irreversible curing process take place either due to the mixing of different low viscosity liquid materials reacting after mixing and/or due to the heating of materials. After the curing process that is taking place into a pre-heated mould, the thermoset material becomes solid and can then be taken out of the mould.

According to a preferred embodiment, the flow length by injection gate is below or equal to 1200 mm. The flow length by injection gate is equal to or at least 20 mm, preferably equal to or at least 200 mm, more preferably equal to or at least 750 mm. The flow length is defined as the distance covered by the injected material from the gate to the end of the flow. Such high flow length allows to reduce the number of gates into the mould and therefore the number of weld lines into the assembly. It reduces the risk of defects caused by such weld lines such as air trap, optical distortion, mechanical weakness, . . . .

In a preferred embodiment, a step of applying a primer on the internal face of at least one of the first glass sheet and/or the second glass sheet can done before the step of injecting a plastic material (step iii.). Such primer can be a silane-based primer. It allows to increase the adherence of the plastic material on the glass sheet, as chemical bonding is created by the primer between the glass sheet and the plastic material.

Such primer covers at least 50%, preferably at least 75%, more preferably at least 90%, even more preferably 100% of the internal face of both the at least first glass sheet and the at least second glass sheet.

In a preferred embodiment, the internal face of at least one of the first glass sheet and/or the second glass sheet may be treated, such as for example by plasma treatment to increase its adhesion to the plastic material before third step. Such plasma treatment can consist of plasma-induced graft polymerization. Plasma-induced graft polymerization, also known as plasma grafting or plasma surface modification, permits to modify the surface properties of materials through the introduction of polymer chains. It involves subjecting the material surface to a low-pressure plasma, which is a partially ionized gas containing highly reactive species such as ions, electrons, and free radicals. During plasma-induced graft polymerization, the plasma species interact with the material surface, causing chemical reactions to occur. These reactions can result in the formation of new covalent bonds between the plasma species and the material surface or the generation of reactive sites on the surface. Subsequently, a monomer solution is applied to the treated surface, and the reactive sites facilitate the attachment and polymerization of the monomer molecules, leading to the formation of a grafted polymer layer.

In a preferred embodiment, at least one of the first glass sheet and/or the second glass sheet is curved. In case the at least first glass sheet is curved, the process of lamination by injection as described before allows to fix the at least second glass sheet to the at least first glass sheet, even if the at least second glass sheet is not curved before lamination. It therefore allows to have a process with only cold bending (not involving heating the glass sheets above 100° C.) compared to hot bending (involving heating to glass sheets to at least 500° C.), which is less energy consuming.

One advantage of such process is the possibility to work with flat glass sheets, which can have been coated and/or printed and/or primerized and/or treated by plasma before being cold bended in the mould and kept bended through lamination process.

One advantage of the present invention compared to classical lamination of glass is to ease the process, therefore leading to lower production cost.

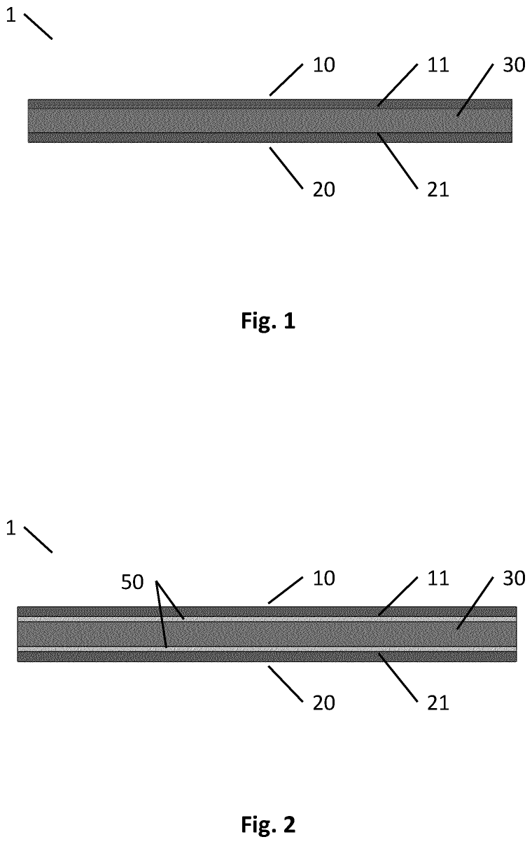

Referring to FIG. 1, an assembly (1) is shown, comprising a first glass sheet (10) having an internal surface (11) and a second glass sheet (20) having an internal surface (21). The two glass sheets (10, 20) are laminated together by an injected plastic material (30).

In this illustrative example, the injected plastic material (30) covers 100% of the internal surfaces (11, 21) of both glass sheets (10, 20).

FIG. 2 illustrates another embodiment, wherein a primer (50) is applied on 100% of the internal surface (11) of a first glass sheet (10) and on 100% of the internal surface (22) of a second glass sheet (20). The primer (50) could be applied on only one of the internal surface (11 or 21) of either the first glass sheet (10) or the second glass sheet (20). Besides, the primer (50) could be applied on a portion of the internal surface (11, 21) of the first glass sheet (10) and/or the second glass sheet (20).

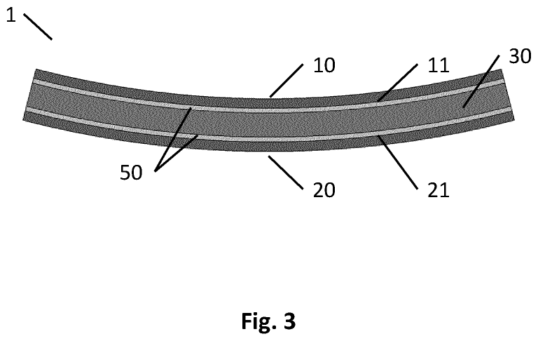

In FIG. 3, the assembly (1) is curved. During the process to create such assembly (1), both the first glass sheet (10) and the second glass sheet (20) can be curved (for example through hot bending process) before the step (step iii.) of injecting a plastic material (30).

Another possibility is that only one of the glass sheet (10 or 20) is curved (for example through hot bending process) before the step (step iii.) of injecting a plastic material (30). The other glass sheet, which is originally flat, is maintained in a curved configuration thanks to the lamination itself. This other glass sheet is therefore bent too, but through a cold bending process.

Another possibility is to cold bend both glass sheets (10, 20) through lamination. For example, both glass sheet may be maintained curved by the mould itself. Then the plastic material is injected, keeping the curvature of both glass sheets.

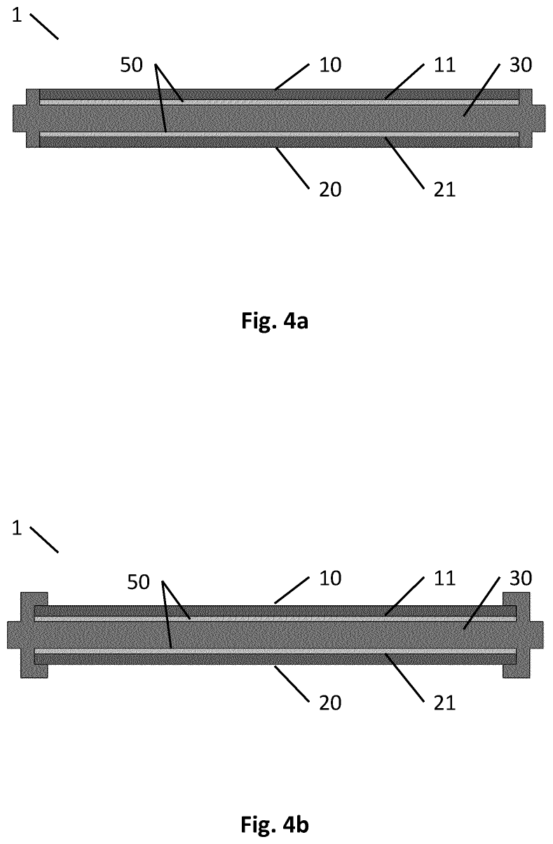

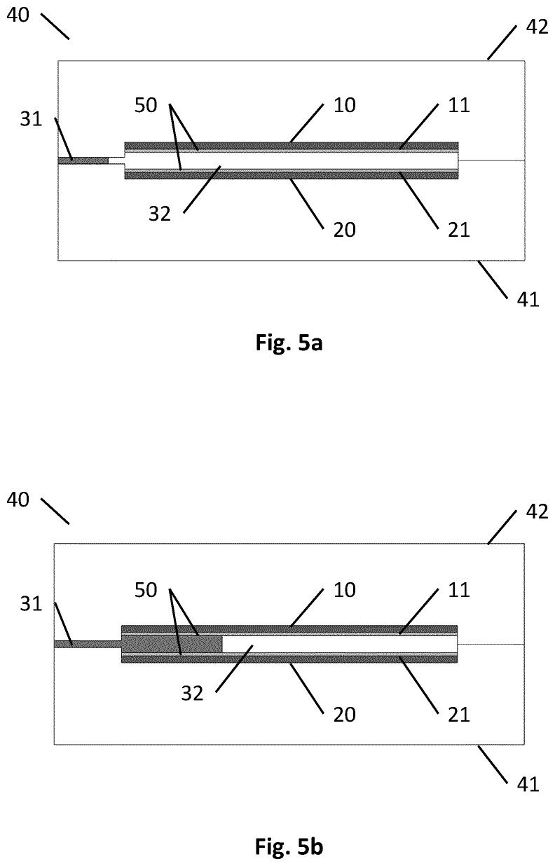

In previous figures, the injected plastic material (30) does not exceed from the internal surface (11, 21) of both glass sheets (10, 20). However, such injected plastic material (30) could extend to cover the edges of one or both of the glass sheets (10, 20), as illustrated in FIG. 4a. The injected plastic material (30) could also even covers a portion of the opposite surface to the internal surface (11, 21) of one or both of the glass sheets (10, 20), as illustrated in FIG. 4b.

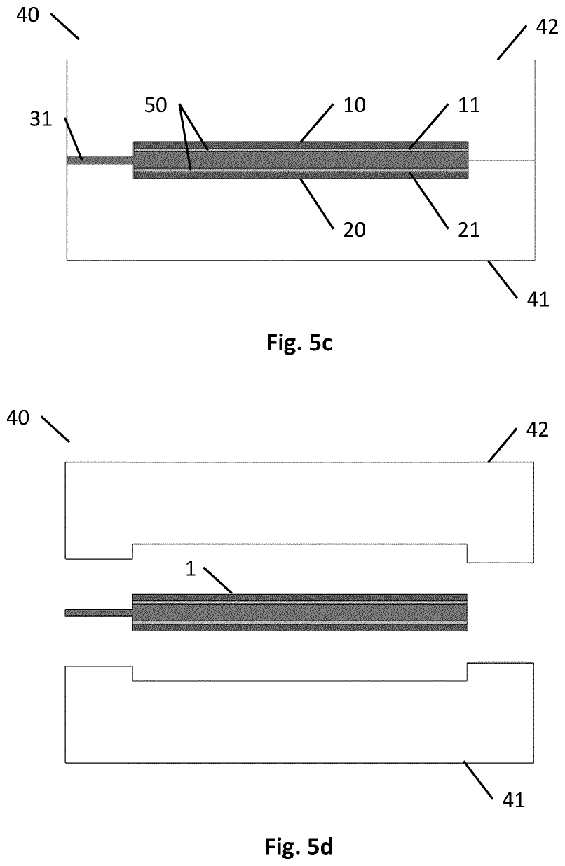

FIG. 5a-d illustrate schematically the process according to the present invention in a mould (40) comprising a fixed part (41) and a mobile part (42). A first glass sheet (10) is provided on the mobile part (42) of the mould (40). This first glass sheet (10) can be adhered to the mobile part through sunction pump (not shown) or any other means that allows to maintain the first glass sheet on the mobile part. A second glass sheet (20) is provided on the fixed part (41) of the mould (40).

In some embodiment, both internal surfaces (11, 21) of both glass sheets (10, 20) are covered by a primer (50) on 100% of both internal surfaces (11, 21). However, a primer (50) can be applied only on a portion of the internal surface (11, 21) of the first and second glass sheet (10, 20). A primer (50) can also be applied on only one of the first or the second glass sheet (10 or 20).

A volume (32) is created between the two glass sheets (10, 20) and the parts of the mould (40).

A plastic material (31) is injected in the volume (32) once the mould (40) is closed, gradually filling in the volume (32), as shown in FIG. 5a-c. The gas present in the volume (32) is allowed to be evacuated.

After cooling step (step iv.) or curing step (step iv.) depending on the type of plastic material used, the mould (40) is opened and the assembly (1) can be released.

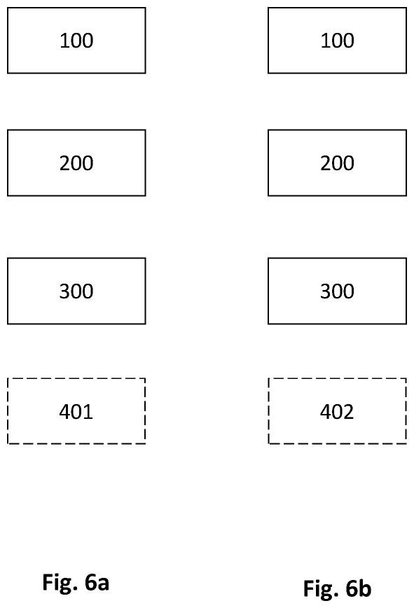

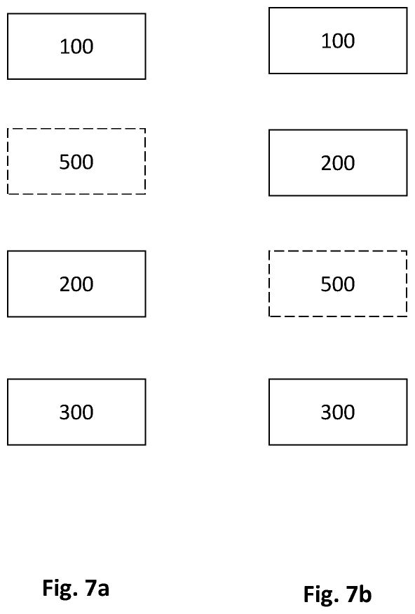

FIG. 6a schematically illustrates the different steps of the process to laminate together at least a first glass sheet (10) having an internal face (11) and at least a second glass sheet (20) having an internal face (21). The process comprises the following steps:
i. Providing (100) the at least first glass sheet (10) and the at least second glass sheet (20);
ii. Placing (200) the internal face (11) of the at least first glass sheet (10) in front of the internal face (21) of the at least second glass sheet (20) to create a volume (32);
iii. Injecting (300) a plastic material (31) into the volume (32) to create a laminate, the plastic material (31) filling at least 50%, preferably at least 75%, more preferably at least 90%, even more preferably 100% of the volume (32), the plastic material (31) being a thermoplastic material or a thermoset material.

FIG. 6a further indicates the step of cooling (401) the thermoplastic material at a temperature below 150° C., preferably below 100° C., more preferably below 80° C. to create an assembly is performed after step iii. (300).

FIG. 6b illustrates the same process, but here further indicates the step of curing (402) the thermoset material for at least 2 minutes, preferably at least 1 minute, more preferably at least 50 seconds to create an assembly is performed after step iii. (300).

FIG. 7a and FIG. 7b illustrate an additional step of applying (500) a primer (50) on the internal face (11, 21) of at least one of the first glass sheet (10) and/or the second glass sheet (20) before the step (step iii.) of injecting (300) a plastic material (31). FIG. 7a illustrates such application of a primer (50) is done before the step (step ii.) of placing (200) the glass sheets (10, 20), while FIG. 7b illustrates such application of a primer (50) is done after the step (step ii.) of placing (200) the glass sheets (10, 20).

In case of the process being processed in a mould (40), the primer (50) could be applied on the internal faces (11, 21) of at least one of the at least first and second glass sheets (10, 20) before the placing (200) of the glass sheets (10, 20) in the mould (40) as illustrated in FIG. 7a.

The primer (50) could be applied on the internal faces (11, 21) of at least one of the at least first and second glass sheets (10, 20) after the placing (200) of the glass sheets (10, 20) in the mould (40) as illustrated in FIG. 7a. In this case, the application (500) of the primer (50) is done inside the mould (40).

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1. An assembly comprising:
at least a first glass sheet having an internal face;
at least a second glass sheet having an internal face;
an injected plastic material laminating the at least first glass sheet and the at least second glass sheet together, the injected plastic material being made of a thermoplastic material or a thermoset material;
wherein the injected plastic material is covering at least 50% of the internal face of both the at least first glass sheet and the at least second glass sheet.

2. The assembly of claim 1, wherein the injected plastic material has a visible light transmission of at least 40%.

3. The assembly of claim 1, wherein the thermoplastic material is a soft polyvinyl chloride or a thermoplastic elastomer.

4. The assembly of claim 3, wherein a melt flow rate of the thermoplastic material is at least 10 g per 10 minutes.

5. The assembly of claim 1, wherein the thermoset material is a polyurethane-based thermoset or a silicone-based thermoset or ethylene-vinyl acetate-based thermoset or a mixture thereof.

6. The assembly of claim 1, wherein at least one of the at least first and second glass sheets has a thickness less or equal to 5.0 mm.

7. The assembly of claim 1, wherein at least one of the at least first and second glass sheets is curved.

8. The assembly of claim 1, wherein the thickness of the injected plastic material is less than or equal to 4.0 mm.

9. A method of laminating together at least a first glass sheet having an internal face and at least a second glass sheet having an internal face, comprising:
providing an at least first glass sheet and an at least second glass sheet;
placing an internal face of the at least first glass sheet in front of an internal face of the at least second glass sheet to create a volume;
injecting a plastic material into the volume to create a laminate,
wherein the plastic material fills at least 50% of the volume, and
wherein the plastic material is a thermoplastic material or a thermoset material.

10. The method of claim 9, wherein the plastic material is a thermoplastic material, and
further comprising cooling the thermoplastic material at a temperature below 150° C. to create an assembly after the injecting.

11. The method of claim 9, wherein the plastic material is a thermoset material, and
further comprising curing the thermoset material for at least 2 minutes to create an assembly after the injecting.

12. The method of claim 9, wherein the at least first glass sheet and the at least second glass sheet are disposed in a mould comprising a fixed part and a mobile part, at least portions of both parts and internal faces of the at least first glass sheet and second glass sheet defining the volume, the at least first glass sheet being provided on one of the part and the at least second glass sheet being provided on the other part.

13. The method of claim 9, wherein a flow length by injection gate is below or equal to 1200 mm.

14. The method of claim 9, further comprising applying a primer on the internal face of at least one of the first glass sheet and/or the second glass sheet before the injecting of the plastic material.

15. The assembly of claim 1, wherein the injected plastic material is covering at least 75% of the internal face of both the at least first glass sheet and the at least second glass sheet.

16. The assembly of claim 1, wherein the thermoplastic material is a thermoplastic olefinic elastomer or a thermoplastic styrenic elastomer or a co-polyester or a co-polyamide or an acrylic-based thermoplastic elastomer or a thermoplastic polyurethane or a mixture thereof.

17. The assembly of claim 3, wherein a melt flow rate of the thermoplastic material is at least 30 g per 10 minutes.

18. The method of claim 9, wherein the plastic material fills at least 75% of the volume.

19. The method of claim 9, wherein the plastic material is a thermoplastic material, and
wherein the thermoplastic material is cooled at a temperature below 100° C. to create an assembly after the injecting.
